(19) United States
(12) Patent Application Publication
(10) Pub. No.: US 2025/0335908 A1
(43) Pub. Date: Oct. 30, 2025

(54) OMNICHAIN SYSTEM AND METHOD FOR REAL WORLD ASSET TOKENIZATION, USE AND DISTRIBUTION

(71) Applicant: Ondo Finance Inc., Greenwich, CT (US)

(72) Inventors: Nathan Allman, New York, NY (US); Gabriel Bianconi, Brooklyn, NY (US); Ian De Bode, Piedmont, CA (US); Cameron Clifton, San Diego, CA (US)

(21) Appl. No.: 19/189,517

(22) Filed: Apr. 25, 2025

Related U.S. Application Data
(60) Provisional application No. 63/639,042, filed on Apr. 26, 2024.

(51) Int. Cl. G06Q 20/38; G06Q 20/40

(52) U.S. Cl. CPC G06Q 20/389; G06Q 20/3825; G06Q 20/401

(57) ABSTRACT

A platform bridges institutional-grade assets and applications with existing public and private blockchains using a unified permission layer. Modifications of permissions on various blockchains are received and executed solely from the platform, thereby governing and dynamically adjusting access to the various blockchains, wherein the unified permission layer enables protocol-level enforcement of access control. If a permissioned asset issuer or service provider changes the permissioning on the platform, all permissions are automatically changed on other chains, thereby allowing an asset issuer to issue compliant assets, or a developer to issue compliant services, and access liquidity and users across a plurality of available ecosystems.

### CROSS REFERENCE TO RELATED APPLICATIONS

The present application claims benefit of provisional application Ser. No. 63/639,042, filed Apr. 26, 2024, the contents of which are incorporated herein by reference.

### FIELD OF THE INVENTION

The invention relates generally to asset exchange environments. More particularly, the instant invention is a computerized method and platform for issuing securities and applications on-chain wherein the scaling of the tokenization, use and distribution are for liquid, real-world assets occurring across different chains, accomplished, in part, from permission changes. In this manner, a hub connects institutional-grade assets and applications with existing blockchains, public or private, thereby enabling asset issuance and utility while preserving liquidity.

### DESCRIPTION OF THE RELATED ART

There are multiple barriers to scaling the tokenization and distribution of real-world assets and applications on-chain and across multiple blockchains. Issuing securities on-chain often requires the asset issuer to implement specific permissions and controls (i.e., who can hold and transfer the token, token clawbacks, freezes, etc.). While these controls are possible on a single chain, their implementation will differ between, for example, Ethereum Virtual Machine (EVM) and non-EVM architectures, i.e., the run-time environments for smart contracts in Ethereum. In addition, real world assets (RWA) are typically issued on a single, often permissioned, blockchain. These assets cannot tap into utility (e.g., use as collateral for repos or other applications) or liquidity on other public, permissionless chains. This significantly reduces the attractiveness of tokenized assets and reduces their value proposition for investors, thereby limiting adoption. Finally, tokenized securities require connectivity into the traditional financial world, often for trading, data and accounting, or custody purposes. Putting securities on-chain requires a tight integration between the public blockchain and other, non-public blockchain systems with low latency and high uptimes.

Regulated institutions are often restricted from transacting or participating on public permissionless blockchains due to their inability to meet their regulatory obligations. For instance, most regulated institutions do not feel comfortable initiating transactions on public permissionless networks. Moreover, for cryptocurrency ownership, on public permissionless blockchains, initiating a transaction requires paying a gas fee with the native token of the blockchain network (e.g., Ethereum), and many financial institutions are not allowed to hold digital assets or cannot do so in an economical fashion. In addition: (1) some public permissionless blockchains do not enable you to choose your validator node, making it impossible for institutions to execute any transaction and issue any asset; (2) many public blockchains do not support asset metadata on-chain or confidential transfers, thus blockchain transactions cannot easily be incorporated in existing administrative systems (e.g., ERP systems); (3) many institutions do not feel comfortable issuing or transferring assets on-chain due to the inherent lack of privacy; (4) many institutions currently are unable to host nodes for any public blockchain, limiting the integration, connectivity and participation that can be achieved between traditional financial systems and players, and public blockchain networks; and (5) current solutions that enable assets to move between public and private blockchains are not sufficiently secure for institutional-grade tokenized real world assets.

For example, Omnichain Fungible Token (OFT) herein provided by the instant platform is a universal token standard used to send, receive, and compose assets across all blockchains. The OFT Standard is a contract for creating and tracking tokens across many chains at the same time. The OFT Standard that has been developed allows fungible tokens (e.g., Layer 1 tokens, Layer 2 tokens, stablecoins, wrapped tokens, governance tokens, utility tokens, and Liquid Staking Tokens (LSTs)), to be transferred across multiple blockchains without asset wrapping or liquidity pools. In addition, Native Token Transfer (NTT) is an open-source, extensible token transfer standard built to be adopted widely across the interoperability ecosystem. This NTT token standard has nearly identical functionality to the OFT Standard. Lastly, the Cross Chain Transfer Protocol (CCTP) enables USDC (the Circle stablecoin) to flow seamlessly and securely between blockchains via native burning and minting. However, CCTP only supports a limited number of blockchains, is only applicable for one asset (i.e., USDC), and gas efficiency and cost are continued shortcomings.

U.S. Pat. No. 11,386,429 (Fan et al.) teaches a cryptocurrency securing method. This prior art disclosure concerns wallet security and not asset issuance. U.S. Pat. No. 11,849,039 (Boorstin) discloses parallel processing in blockchain transactions, emphasizing speed and efficiency in transaction validation. Transaction flow is optimized, whereas, here, the instant invention actively modifies blockchain states. U.S. Patent Pub. No. 20230367788 (Grant et al.) teaches bridging digital assets, i.e. bridging transactions across blockchains. Absent in bridging mechanisms are permissioned issuance and compliance, as taught herein. Other prior art teach deployment optimizations and messaging between chains. U.S. Patent Pub. No. 20230289337 (Zarick et al.) shows a messaging layer for blockchain communication. However, of note is that the instant invention additionally focuses on compliant issuance and not just messaging between chains. Whereas the prior art shows how to move transactions and messages, taught herein are modified states with compliance issuance across multiple chains.

Thus, some environments for omnichain deployment are contemplated. However, they do not support all environments (e.g., many non-EVM architectures (Solana) are not supported), they do not support permissioned tokens (i.e., tokens with transfer restrictions) and/or do not enable configurable security when bridging, to name but a few shortcomings of existing blockchain implementations. They also do not contemplate how to create a tight coupling between on-chain and off-chain financial environments to ensure the tokenized assets can be serviced appropriately (e.g., prices can be updated in near real time, proof of reserves and custody can be published on-chain, etc.). Needed, then, is a platform (system and computerized method) designed to solve these restrictions and enable institutions to finally participate in web3 by making it easy to issue and service assets omnichain, deploy services omnichain while preserving liquidity, and to do so on institutional-grade infrastructure that enables them to meet their regulatory requirements across all chains.

### SUMMARY OF THE INVENTION

It is an objective of the present invention to provide a platform which enforces blockchain permissions at the protocol level and is not merely an execution framework.

It is further an objective to provide a platform that dictates blockchain access control using permissioning that interacts with the validator nodes, thereby providing more than simply a consensus mechanism for one blockchain.

It is further an objective to provide a platform which includes modules that do more than encrypt and secure transactions but rather actually control access at a protocol level such that the system operates at a governance layer, not just execution.

It is further an objective to secure the chain by staking real world assets to permissioned validators, and this permissioned validator set can validate transactions and also publish prices on-chain and post proof of reserves.

It is further an objective to provide a platform that restakes assets across permissioned and permissionless blockchains while maintaining institutional compliance.

It is further an objective to provide a platform which includes a staking security module that interacts with both the consensus and execution modules, ensuring that staked and restaked assets maintain compliance with validatory requirements.

Accordingly, the instant platform integrates execution and consensus into a unified permission structure which modifies various blockchain permission from a single platform. Termed herein “Ondo Chain”, “platform” or “environment” (used interchangeably), provided is a purpose-built platform for the tokenization of regulated securities, including, in combination, public permissionless blockchain elements and security and compliance features of permissioned enterprise solutions. Ondo Chain is a proof-of-stake omnichain layer one blockchain, secured by tokenized real-world assets (RWAs) and liquid staking tokens (LSTs) and with native integrations into relevant systems from traditional finance (e.g., Broker Dealers).

Ondo Chain acts as a hub connecting institutional-grade assets and applications with existing public blockchains and Traditional Finance systems (where relevant). Ondo Chain abstracts away the complexities of issuing real world assets (permissioned and permissionless) and building omnichain applications by establishing a unified global state and permissioning layer, allowing asset issuers to issue compliant assets and developers to issue compliant services, and access liquidity and users across every available ecosystem.

More particularly, comprehended is a system, comprising: a platform, the platform including a memory and a processing device operatively coupled to the memory, to perform operations comprising the steps of: via a security and permissioning module: (i) enabling secure communication between the platform and various blockchains, each blockchain including a plurality of validator nodes for participating thereon, each blockchain having a required permission and in a current state, and, (ii) establishing a unified permission layer across the various blockchains such that modifications of the permission on the various blockchains are received and executed solely from the platform, thereby governing and dynamically adjusting access to the various blockchains, wherein the unified permission layer enables protocol-level enforcement of access control for the various blockchains, and, (iii) propagating the modifications across the various blockchains; via an execution module communicating with the security and permissioning module and the unified permission layer, validating transactions within constraints of the unified permission layer and between each of the validator nodes, and reading and initiating state changes to the current state across the various blockchains to thereby form an updated state and propose valid blocks, without maximal extractable value (MEV), for the various blockchains; via a consensus module communicating with the execution module, determining a consensus networking topology across any of the validator nodes participating so a consensus can be reached and so the updated state can be propagated; whereby the platform bridges one or more assets or services with existing public and private versions of the various blockchains using the unified permission layer, thereby allowing an asset issuer to issue compliant versions of the assets and access liquidity and users across the various blockchains.

The platform further comprises, via a staking security module, communicating with the consensus module and the security and permissioning module, wherein the staking security module stakes or restakes the assets.

Accordingly, the platform bridges institutional-grade assets and applications with existing public and private blockchains using a unified permission layer, thereby allowing said asset issuer to issue compliant assets, and said developers to deploy compliant services, and access liquidity and users across a plurality of available ecosystems.

### BRIEF DESCRIPTION OF THE DRAWINGS

FIG. 1 shows a flow chart of the instant overall system architecture.

FIG. 2 outlines the process of issuing permissioned assets and services within the Ondo Chain architecture, thereby depicting the details of the security and permission module and how it instantiates secure bridging and permissions across chains.

FIG. 3 depicts the process of updating permissions for assets natively omnichain within the Ondo Chain architecture while also showing the details of the unified permission layer of the security and permission module for updated permission settings.

FIG. 4 shows a flow chart depicting the details of the mechanism for the validation of the cross-chain bridging transaction.

FIG. 5 shows a flow chart depicting further embodiments of the details of the mechanism for the validation of the transaction including illustrating the process for changing security settings within the Ondo Chain omnichain architecture.

FIG. 6 presents three distinct flows within the Ondo Chain architecture: native omnichain redemption, permissioned services, and staking or restaking of real-world assets (RWAs) to thereby depict illustrative flows for sample use cases.

The flow charts accompanying this description, as follows, represent the modular architecture of the system and the interactions between its key components. Each module is depicted as an element in the process flow, with communication pathways that define their roles within the broader network. Each of the modules communicate with each other as follows: the execution module communicates with the consensus module via the engine API. The Engine API enables the execution module to pass bundles of transactions to the consensus module, with the logic to potentially change between execution and consensus algorithms (e.g., when the execution module is EVM and the consensus module is CometBFT). This interface also supports flexible integration between different execution and consensus algorithms. The execution module needs to communicate to the staking security module in case users stake eligible assets directly on Ondo Chain to secure the network (similar to liquid staking on Ethereum). Further, the execution module needs to communicate with the security and permissioning module to verify whether a state change is allowed for an Ondo Chain asset or service on Ondo Chain or any connected blockchain. As such, the execution module communicates with the security and permissioning module and the unified permission layer, validating transactions within constraints of the unified permissions layer and between each of said validator nodes to thereby form an updated state and propose valid blocks for the various blockchains.

The security and permissioning module needs to communicate any changes to security or permissioning settings for Ondo Chain assets and contracts to the execution module. The security and permissioning module needs to communicate any changes in staked asset balances on other chains to the restaking security module.

The consensus module needs to communicate the block rewards and/or slashing penalties to the staking security module so the staking security module can accurately update the balances in the Ondo Chain restaking contracts across chains.

The staking security module communicates with the consensus module to delegate the restaked assets to node operators (i.e., entities running the execution and consensus modules).

### DETAILED DESCRIPTION OF THE PREFERRED EMBODIMENT

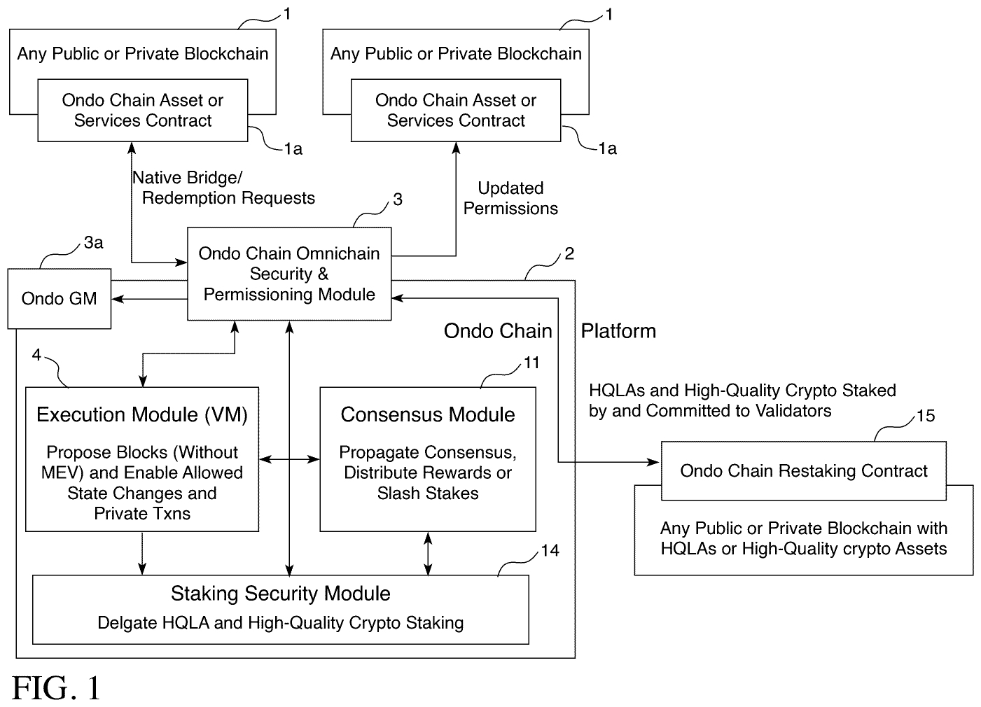

Referencing then FIGS. 1-6, embodiments and the operations shown in the drawings and described in this specification are computer-implemented systems and methods. This means it can be implemented in digital electronic circuitry, or in computer software, firmware, or hardware, including the structures disclosed in this specification or in combinations of one or more of them. The operations can be implemented as operations performed by a data processing apparatus on data stored on one or more computer-readable storage devices or received from other sources. A data processing apparatus, computer, or computing device may encompass apparatus, devices, and machines for processing data, including, by way of example, a programmable processor, a computer, a system on a chip, or multiple ones, or combinations, of the foregoing. The apparatus can include special purpose logic circuitry, for example, a central processing unit (CPU), a parallel graphics processing unit (GPU), a field programmable gate array (FPGA) or an application-specific integrated circuit (ASIC). The apparatus can also include code that creates an execution environment for the computer program in question, for example, code that constitutes processor firmware, a protocol stack, a database management system, an operating system (for example, an operating system or a combination of operating systems), a cross-platform runtime environment, a virtual machine, or a combination of one or more of them. The apparatus and execution environment can realize various different computing model infrastructures, such as web services, distributed computing and grid computing infrastructures. Thus, it should be known a computer program is an executable program of instructions which can be executed on one computer or on multiple computers that are located at one site or distributed across multiple sites and interconnected by a communication network. Generally, a computer will also include or be operatively coupled to receive data from or transfer data to, or both, one or more mass storage devices for storing data. A computer, or node, can be embedded in another device, for example, a mobile device, a personal digital assistant (PDA), a game console, a Global Positioning System (GPS) receiver, or a portable storage device. Devices suitable for storing computer program instructions and data include non-volatile memory, media and memory devices, including, by way of example, semiconductor memory devices, magnetic disks, and magneto-optical disks. The processor and the memory can be supplemented by, or incorporated in, special-purpose logic circuitry. Additionally, processors for execution of a computer program include, by way of example, both general-and special-purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data.

Embodiments can be implemented using the computing devices interconnected by any form or medium of wireline or wireless digital data communication (or combination thereof), for example, a communication network. Examples of interconnected devices are a client and a server generally remote from each other that typically interact through a communication network. A client, for example, a mobile device, can carry out transactions itself, with or through a server.

The relevant network herein is a blockchain network, i.e. various blockchains 1, public or private, which may comprise one or more blockchains 1, thus “a” or “various” as used in the claims means one or more in all instances. In general, a typical blockchain 1 network consists of several interconnected components that work together to maintain and operate the various blockchains 1 Nodes (not shown) are individual computers or devices that participate in the blockchain 1 network. The term nodes or computer are meant to capture the same device by definition and may be used interchangeably. There are different types of nodes, including full nodes, which maintain a complete copy of the blockchain 1, and lightweight nodes, which rely on full nodes for blockchain data. Nodes validate transactions, create new blocks, and/or propagate data across the network. Rules that govern the operation of the blockchain 1 network are defined by a blockchain protocol. Included may be the protocols for block creation, transaction validation, consensus mechanisms (such as Proof of Work or Proof of Stake), and network communication. A consensus mechanism is a protocol that ensures all nodes in the network agree on the validity of transactions and the order in which they are added to the blockchain 1 Consensus mechanisms prevent double spending and maintain the security and integrity of the blockchain 1. A validator node herein is an entity that runs both the execution and consensus module (at a minimum) and is connected to other validator nodes so that consensus of the network state can be reached. The blockchain data structure is a decentralized and distributed ledger that records all transactions in chronological order. It typically consists of a chain of blocks, where each block contains a list of transactions, a timestamp, and a reference to the previous block, forming a linked list. Transactions are records of data exchanged between participants on the blockchain 1 network. Each transaction contains information such as the sender, recipient, amount transferred, and any additional data. “Staking” refers to the act of locking up tokens in a blockchain network to participate in consensus, either by validating transactions or delegating to a validator. “Restaking” refers to reusing already-staked assets across multiple protocols or services. Therefore, “staking” as used in the claims to refer to both staking or restaking depending on the cross-chain context. Transactions are grouped together into blocks and validated by network nodes. Cryptographic hash functions are used to create digital fingerprints (hashes) of data, such as transactions and blocks, on the blockchain 1. These hashes provide a unique identifier for each piece of data and ensure its integrity and immutability. Next, digital signatures are cryptographic mechanisms used to verify the authenticity and integrity of transactions on the blockchain 1. Each participant in the network has a unique private key used to sign transactions, and a corresponding public key is used to verify the signature. Smart contracts are self-executing contracts with predefined rules encoded onto the blockchain 1. They enable the automation and execution of contractual agreements between parties without the need for intermediaries. Smart contracts are typically deployed on blockchain platforms, such as Ethereum. Finally, the network infrastructure consists of the physical and logical components that enable communication and data exchange between nodes in the blockchain 1 network. This includes internet connectivity, peer-to-peer networking protocols, and communication protocols, such as TCP/IP.

The flow chart of FIG. 1 illustrates the herein “Ondo Chain” architecture of the platform 2 which operates across any public or private blockchain 1. It begins with an Ondo Chain Asset or Services contract 1a, enabling native bridge and redemption requests. These requests interact with updated permissions managed through the Ondo Chain platform 2. The architecture supports native omnichain permissioned asset issuance and redemption via Ondo Global Markets, or Ondo GM 3a, as well as permissioned services with a global unified state. High-quality liquid assets (HQLAs), equities and other high-quality crypto assets are staked by validators and committed through the restaking contract 15, contributing to institutional-grade infrastructure and enhanced network security. This restaking is sourced from any supported blockchain 1 possessing qualifying assets, reinforcing the permissioned and interoperable nature of the ecosystem.

With continued reference then to FIGS. 1 through 6, particularly FIG. 1, shown is the “Ondo Chain” platform 2 or environment (terms used interchangeably). Provided is a purpose-built platform 2 for the tokenization, use and distribution of regulated securities, including, in combination, public permissionless blockchain elements and security and compliance features of permissioned enterprise solutions. Ondo chain platform 2 is a proof-of-stake omnichain layer one blockchain 1 secured by tokenized real-world assets (RWAs) and liquid staking tokens (LSTs) and with native integrations into relevant systems from traditional finance (e.g., Broker Dealers). The platform 2 is a public L1 proof-of-stake blockchain 1 designed to catalyze both the tokenization and use of regulated securities on-chain, but across all various blockchains 1. It does this by combining elements of public permissionless blockchains 1 with the security and compliance of private, permissioned ones, by piloting the instant way to tokenize public securities, and by directly addressing the most significant infrastructure barriers that exist today. The elements combined include, in part, the security and permissioning module 3 capturing the institutional grade components of private chains, along with some features of the execution module 4 (i.e., private transactions and metadata).

The execution module 4 communicates with the consensus module 11 via the Engine API, which enables the execution module 4 to pass bundles of transactions (“TXN”) to the consensus layer. Because of this, a consensus networking topology is determined across any of the validator nodes participating so a consensus can be reached and so any updated state can be propagated. This interface also supports flexible integration between different execution and consensus algorithms—for example, pairing an EVM-based execution module with a CometBFT consensus module. The execution module 4 also interacts with the staking security module 14, particularly in cases where users stake eligible assets directly on Ondo Chain platform 2 to help secure the network, in a manner similar to liquid staking on Ethereum. In addition, it must communicate with the security and permissioning module 3 to validate whether a proposed state change is permissible for an Ondo Chain asset or service 1a—either on Ondo Chain platform 2 itself or on any connected blockchain 1. The security and permissioning module 3 sends updates to the execution module 4 regarding changes to security or permissioning rules governing Ondo Chain assets and services contracts la It also relays any changes in staked or restaked asset balances on other chains to the staking security module 14. Meanwhile, the consensus module 11 communicates block rewards and slashing penalties to the staking security module 14, ensuring the maintenance of accurate balances in Ondo Chain's cross-chain restaking contracts. Finally, the staking security module 14 delegates restaked assets to node operators—entities responsible for running the execution and consensus modules—based on inputs from the consensus layer.

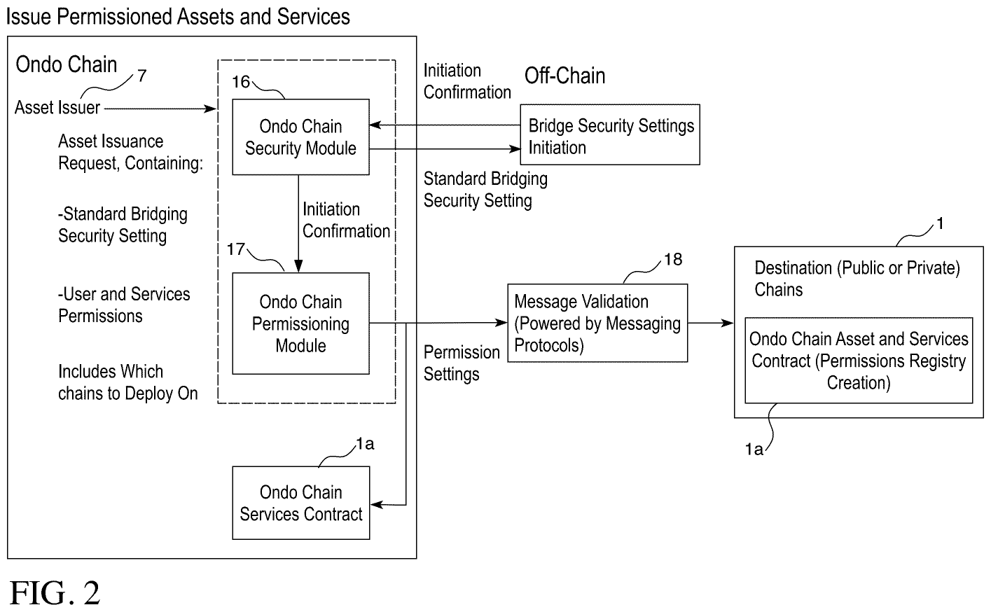

FIG. 2 outlines the process of issuing permissioned assets and services within the architecture of the Ondo Chain platform 2. The flow begins with an asset issuance request by an Ondo Chain Asset Issuer 7, which includes elements such as standard bridging security settings, user information, and associated services. This triggers an initiation and confirmation sequence involving the Ondo Chain security module 16, which is one sub-module of the security and permissioning module 3 The request then proceeds to the Ondo Chain permissioning module 17, the other sub-module of the security and permission module 3, where permission settings are applied-specifying which chains the assets or services will be deployed on. Next, the process engages the asset and services contract 1a and an off-chain message validation step 18 powered by messaging protocols. The final stage involves the creation of a permissions registry within the Ondo Chain asset and services contract 1a, completing the secure and permissioned deployment flow.

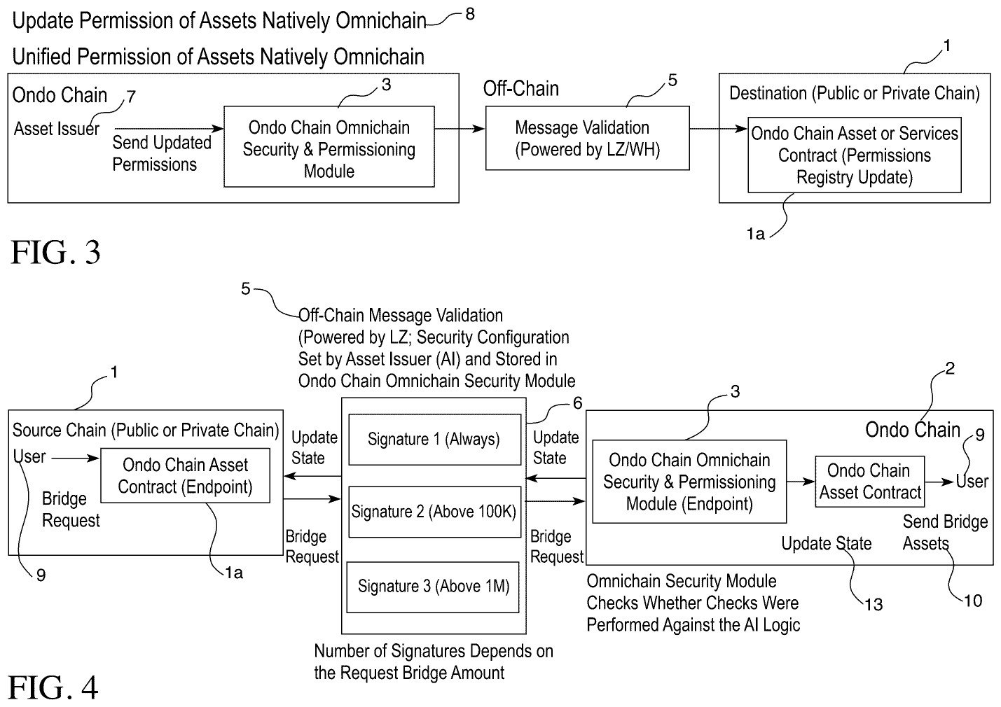

FIGS. 3 and 4 depict the process of updating permissions for assets natively omnichain within the architecture of the Ondo Chain platform 2. The process begins with the Ondo Chain Asset Issuer 7 sending updated permissions off-chain to the Ondo Chain security and permissioning module 3. This update is subject to off-chain message validation 5 powered by messaging protocols like LZ or WH, using a security configuration predefined by the Asset Issuer 7. Validation requires multiple signatures 6 depending on the size of the bridge request: Signature 1 is always required, with additional signatures (2 and 3) required for requests exceeding certain amounts, e.g., 100K and, e.g., 1M USD, respectively (other values and denominations possible). After validation, a bridge request is initiated. The omnichain security module confirms that the required checks have been executed per the Asset Issuer's logic. Finally, the permissions registry is updated within the Ondo Chain asset or services contract 1a, and the state is updated to reflect the change. The updated permissions enable bridged assets to be sent across chains under the new settings.

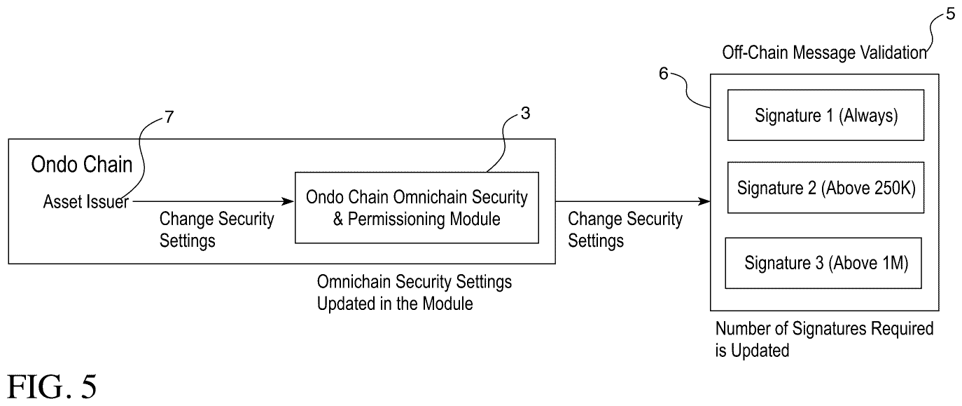

As above, one aspect of the present invention involves storing preconfigured security settings for omnichain messaging, regardless of the underlying messaging protocol. Preconfigured security settings, fit for purpose for asset issuers, are stored in the security and permissioning module 3, that determine how to securely communicate and give/receive instructions to/from any various blockchain 1 that an Ondo Chain asset or Ondo Chain services contract 1a is on. Termed herein off-chain message validation 5, an example of this security setting could be: (1) one required signature from the asset issuer regardless of transfer amount. This required signature should only be given if the asset issuer has verified that the chain is live (i.e., not halted) and sufficiently secure (i.e., the network is not compromised); (2) one additional signature required by the asset issuer if the transaction amount is above, e.g., 100K; (3) two additional signatures required by the asset issuer if the transaction amount is above, e.g., 1M (see above and FIG. 4, for example). Ondo Chain platform 2 will store the security settings for each asset issuer in the security and permissioning module 3, such that the number of signatures 6 required can be tailored and updated by the asset issuers 7 in one place. Ondo Chain 2 provides a standard, recommended security setting, but asset issuers 7 can choose to update this as they see fit. By storing their preferred security setting in the security and permissioning module 3, they are not locked into using one messaging provider-Ondo Chain platform 2 has the flexibility to leverage multiple message providers to lower costs for asset issuers 7, or always ensure the best possible security in case there are concerns with one (see FIG. 5, for example).

The Ondo Chain platform 2 acts as a hub connecting institutional-grade assets and applications with existing public blockchains 1 and TradFi systems (where relevant), i.e. various blockchains 1 Ondo Chain platform 2 abstracts away the complexities of issuing permissioned assets and building omnichain applications by establishing a unified global state and permissioning layer, termed herein unified permission layer 8, allowing asset issuers 7 to issue compliant assets and developers to deploy compliant services/applications 1a, and access liquidity and users across every available ecosystem. An example of the unified permission layer is shown in FIGS. 3 and 4. The nodes (entities that are running consensus and execution modules together and are connected to each other) will store the state of Ondo Chain assets 10 across chains. This updated state is updated through communication via the security and permissioning module 3.

FIG. 5 further illustrates the process for changing security settings within the Ondo Chain platform 2 omnichain architecture. The process starts with the Ondo Chain Asset Issuer 7 initiating a change to the security configuration. This update is transmitted to the Ondo Chain security and permissioning module 3, where the new omnichain security settings are recorded. Off-chain message validation 5 is then performed, and the number of required signatures depends on the security level and transaction size: Signature 1 is always required, while Signature 2 is added for changes above, e.g., 250K, and Signature 3 for those above, e.g., 1M. Once validated, the updated security parameters are enforced by the system, ensuring that the required number of authorizations matches the new thresholds.

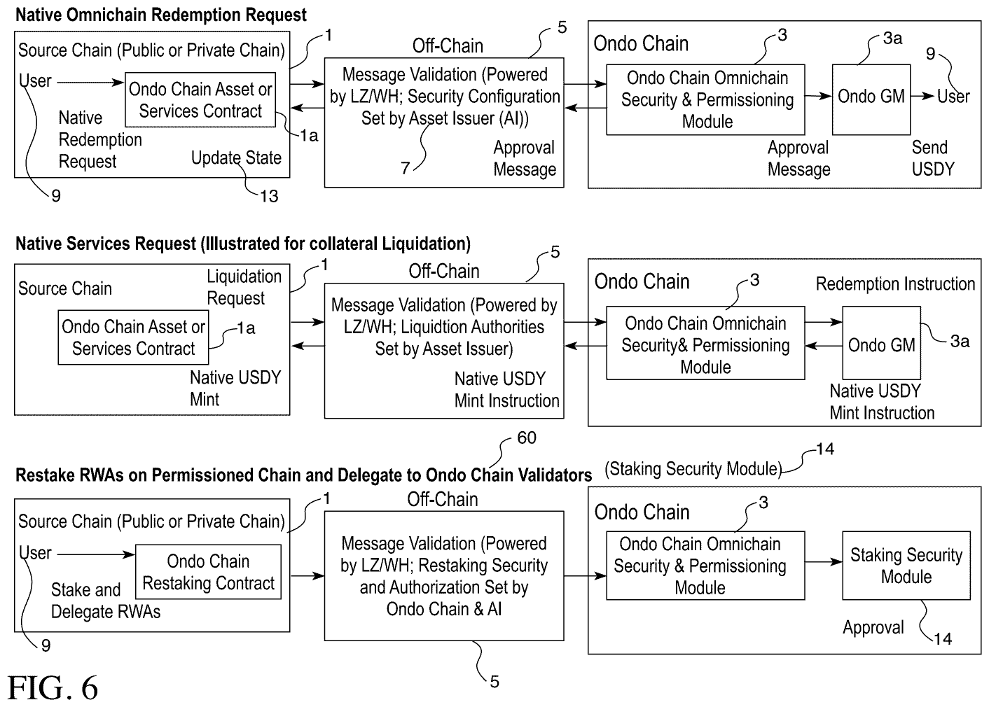

FIG. 6 presents three distinct flows within the Ondo Chain architecture: native omnichain redemption, permissioned services, and restaking of real-world assets (RWAs). In the first flow, a native omnichain redemption request is initiated off-chain and undergoes message validation 5 powered by LZ or WH, with security parameters defined by the asset issuer 7. Upon validation, an approval message is sent, allowing the user to receive the designated asset (e.g., USDY). In the second flow, a native services request, exemplified by a collateral liquidation, is validated 5 through off-chain mechanisms. The liquidation authorities are pre-defined by the asset issuer 7, leading to an Ondo Chain redemption instruction and subsequent native USDY mint instruction. The third flow involves restaking RWAs on a permissioned chain. After message validation 5 and checks based on staking security configurations defined by Ondo Chain 2, the assets are delegated to a permissioned validator set, termed herein Ondo Chain validators 60, reinforcing network participation and security. Primary security will be provided by the Ondo Chain validators 60 which is a permissioned validator set that run their own decentralized verifier network (DVN), with additional DV Ns used at higher transaction amounts. Ondo Chain platform 2 will also make it easy for developers to create natively omnichain applications by acting as the ‘source of truth’ for key pieces of information (e.g. KYC status, sanction lists, collateral amounts, etc.) and govern certain issuance/redemption smart contracts across supported chains.

A subset of Ondo Chain validators 60 will automatically verify directly with custodians or broker dealers that the balances of every RWA token as reported by the token minter are fully backed by the appropriate amount and type of underlying assets. This process mitigates risks of under-collateralization or misreporting, which can lead to insolvency or loss of user trust in the system. This approach shifts the responsibility from a single centralized minter to a distributed network of validators, increasing transparency and reducing the risk of fraud. By empowering validators to govern these processes, Ondo Chain platform 2 can maintain a more secure, decentralized, and transparent issuance of tokenized assets, fostering greater confidence among institutional and retail participants alike.

Although Ondo Chain validators 60 will be permissioned, the rest of the chain will be open, allowing anyone to issue tokens, develop apps, or act as a user or investor. User identification and permissions is a core feature of Ondo Chain platform 2, allowing asset issuers 7 and application developers to implement permissioning and transfer restrictions at a contract level where appropriate.

Because Ondo Chain validators 60 can run nodes with just Real World Assets, regulated institutions (e.g., banks, broker dealers) can run validator nodes for the Ondo Chain over time. What results is a tight coupling between on-chain and off-chain financial environments to ensure the tokenized assets can be serviced appropriately (e.g., prices can be updated in near real time, proof of reserves and custody can be published/posted on-chain, etc.). The publishing and/or posting means the offchain collateral can be verified for supported assets.

In use, therefore, and with continued reference to FIGS. 1-6, Ondo Chain platform 2 enhances and combines concepts (e.g., LayerZero OFT/Wormhole NTT token standards for omnichain asset deployment) and secure, configurable bridging; other L1 architectures, e.g., Provenance, for institutional compliance features; HQLA restaking services, e.g., Exocore, with the instant technology for omnichain asset permissioning and liquidity (i.e., directive tokenization), M-of-N redundancies built in for cross-chain messaging and deployment, and native implementations for omnichain functionality at the node level (e.g., similar to precompiles for complex cross-chain messaging workflows)). When a developer deploys a contract on Ondo Chain platform 2 the contract is natively omnichain through the built-in messaging functionality that exists between Ondo Chain platform 2 and the endpoints it has established on all connected chains. Endpoints could be relayer nodes, adapters, or lightweight proxy contracts deployed on each connected chain. These endpoints serve as the interface to receive messages from the platform 2 and send them to the destination contracts on other chain. The built-in messaging functionality is a cross-chain messaging protocol which allows a smart contract to send and receive messages (function calls, state updates, etc.) to/from endpoint on other chains. The complexities of different chains (gas, consensus, etc.) are abstracted, allowing a contract to be deployed once and communicate with others as if they were on the same network. The contract deployed on Ondo Chain platform 2 can easily communicate to these Ondo Chain endpoints on other chains and vice versa. Imagine a developer that deploys a lend/borrow contract on Ondo Chain platform 2 (the Ondo Chain lend/borrow contract). Now imagine a user 9 who wants to use assets 10 they own on another chain 1 (e.g., Ethereum) as collateral for the Ondo Chain lend/borrow contract. The user 9 will approve the Ondo Chain lend/borrow contract, and once approved, the user can initiate a transaction on Ethereum that transfers the user's assets 10 on Ethereum into the Ethereum instance of the Ondo Chain endpoint. Once the assets 10 have moved into the Ethereum instance of the Ondo Chain endpoint, the Ethereum instance of the Ondo Chain endpoint communicates the user's collateral balance to the lend/borrow contract, which then enables the user 9 on Ondo Chain platform 2 to take out a loan from the Ondo Chain borrow/lend contract's liquidity (even though the collateral remains on Ethereum). This same logic would work for a user 9 who wants to use assets 10 they own on Ondo Chain platform 2 as collateral for a loan on a different chain 1

Assets 10 issued on platform 2 adhere to the Ondo Chain Permissioned Omnichain Security Token Standard (OFT), an omnichain fungible token standard with permissioning and enhanced compliance functionality (e.g., transfer restrictions) that can be enforced across chains. The omnichain fungible token framework is designed with built-in compliance features such as transfer restrictions, asset-holder whitelisting, and jurisdictional enforcement logic. As above, asset ownership and permissioning across chains will be stored and updated in the security and permissioning module 3. This module 3 acts as the authoritative source of truth and includes configurable logic for transaction validation, incorporating M-of-N signature requirements that scale with transaction characteristics (e.g. value, jurisdiction, or risk profile). This module 3 will also enforce the configurable security standard (as defined by the asset issuer) with M-of-N transaction validation redundancy built in for cross-chain messages (powered by other cross-chain messaging providers like LayerZero (LZ) or Wormhole (WH), and potentially direct interchain communication protocols such as Solana's C-level messaging). Unlike these providers, which rely respectively on an Oracle/Relayer pair or a Guardian validator network, the instant Ondo Chain security framework allows each cross-chain transaction to be subject to additional off-chain validation steps prior to finalization. For instance, an issuer 7 may specify that a transfer of high-value tokenized securities must not only pass through the Guardian network (if using Wormhole) but also be approved via out-of-band signatures logged in the security and permissions module 3 These off-chain validations could involve querying chain status (e.g., via Chainlink oracles to confirm liveness), issuer back-office systems, or compliance engines.

Assets 10 that represent traditional public securities will be able to be redeemed natively omnichain via Ondo Global Markets 3a by those who have an Ondo Global Markets 3a account (and for those assets that are issued as an Ondo Chain Permissioned Omnichain Security Token). When a user 9 wants to redeem an asset 10, it will work similarly to a native mint/burn transaction (see FIG. 6 diagram 1 for example flows), but the user 9 will be able to redeem the underlying security against stablecoins directly on Ondo Chain platform 2 via their Ondo Global Markets 3a account that is connected to a traditional broker dealer.

Applications that developers build on Ondo Chain platform 2 will be natively cross-chain. This means asset issuers and developers 7 will be able to access users and liquidity across every connected “ecosystem”, i.e. public and private blockchains 1 layer solutions, decentralized applications (dA pps), liquidity pools, governance frameworks, and other interoperable networks. Developers and asset issuers 7 are able to have a single place of logic that can maintain the state and permissioning of assets and data across all connected chains, effectively enabling “Write Once, Use Everywhere”. The chain supports native implementations (i.e., implement by a consensus module 11 at the consensus level) of operations used by messaging protocols, materially reducing the gas cost of running a hub application there. Not only can they interact with liquidity across ecosystems, but they can do so with gas-efficient cross-chain abstractions because the consensus module 11 natively implements the logic commonly needed in messaging protocols (e.g., replay protection, receipt verification, and route validation).

Ondo Chain platform 2 provides abstractions for important but complex cross-chain messaging workflows (e.g., smart message routing and M-of-N redundancy) to improve the developer experience for those building on top of Ondo Chain platform 2 make these transactions significantly cheaper for Ondo Chain users 9, and enable smart contracts to have access to liquidity of traditional capital markets (via direct access to Ondo GM). An example of this would be in the case of a forced liquidation of a user where the collateral used are traditional public securities (tokenized via Ondo GM 3a with the Permissioned Omnichain Security Token Standard). In this instance, the smart contract that holds the collateral is authorized to send a native burn/redemption requested to the Ondo Chain security module 16, which, after approving the request, routes the instruction to Ondo Global Markets (GM) 3a account to obtain the principal value of the underlying collateral, thereby making the smart contract lenders whole, independent of the chain the contract is running on.

Institutional compliance requirements are built into the protocol, including permissioned validators, optional transaction privacy with regulator or auditor visibility, metadata on-and-off chain, asset permissioning (including transfer restrictions) and advanced identity features. This implementation includes architectural components of third-party architecture, such as Provenance or Solana, but with native omnichain support (i.e., the “Write Once, Deploy Anywhere” functionality, omnichain permissioning and enhanced gas savings for any omnichain transaction).

Through the staking security module 14, Ondo Chain platform 2 enables network security by staking a variety of high-quality assets. This includes both RWAs (e.g., USDY) and major L1/L2 tokens and LSTs (e.g., staked ETH, staked SOL, staked APT, etc.), providing strong security at low cost while offering yield on otherwise idle assets. These assets can also be financialized assets selected from the group consisting of synthetics, cross chain liquidity tokens and security tokens. These and other high-quality assets can be staked on other blockchains 1 (private and public) and can be committed into the Ondo Chain restaking smart contracts to provide Ondo Chain security.

### EXAMPLE AND DEFINITIONS

The following examples and definitions show complementary components used to build out the environment, in line with the aforementioned.

Ondo U.S. Government Fund (OUSG): Permissioned assets that are issued on various public blockchains 1 Currently deployed is the module technology to enable permissioning (i.e., who can hold the asset on the supported public blockchains), constant minting and burning against stablecoins and the underlying collateral (e.g., treasuries), and conversion between a rebasing and non-rebasing version. Ondo U.S. Government Fund is the tokenized treasury product, e.g., https://ondo.finance/ousg. Tokenizing securities today are often represented as tokens that represent ownership in a fund structure that is distinct from the underlying assets. For example, OUSG tokens represent ownership in a new fund that Ondo set up, Ondo I LP, which invests in other tokenized treasury funds onchain (e.g., BUIDL, Benji, etc.). In addition, this approach requires the asset issuer (i.e., Ondo) to onboard their own users and perform K now Y our Customer (KYC) checks on their permissioned user base.

Ondo Global Markets (GM) 3a This component enables the tokenization of publicly listed securities across blockchains. These assets are issued as quasi-permissionless bearer-like instruments. Each token represents a total return tracker of a corresponding equity or security. Each token is fully collateralized by the associated securities in a brokerage account.

Flux Finance: Permissioned lending protocol that essentially functions as a repo market, where OUSG is the collateral asset and USDC is the liquidity asset. Only permissioned users can supply OUSG and take out a repo, whereas everyone can supply USDC for liquidity. Only permissioned users can also initiate a liquidation of collateral, should this be necessary. This is a good example of a service that is often employed in traditional finance (and one that requires permissioning) that is deployable on platform 2 in an Omnichain fashion.

Ondo Bridge: Secure native bridging of OUSG and other Ondo permissioned assets between various chains. It leverages multiple bridging technology providers (e.g., Axelar, LayerZero and Wormhole) with an Ondo Risk Management overlay to provide bridging security that scales with the transfer amount, with additional signatures required to bridge larger amounts. In addition, when bridged, Ondo tokens are not locked in a smart contract on the source chain. They are burned on the source chain and re-minted on the destination chain, further eliminating a common attack vector.

Provided then is a platform and method that bridges institutional-grade assets and applications with existing public and private blockchains 1 using the unified permission layer, thereby allowing an asset issuer to issue compliant assets, or a developer to issue compliant services, and access liquidity and users across a plurality of available ecosystems.

While the invention has been described with reference to one or more embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. In addition, all numerical values identified in the detailed description shall be interpreted as though the precise and approximate values are both expressly identified.

We claim:

1. A system, comprising:
a platform, said platform including a memory and a processing device operatively coupled to said memory, said memory having executable instructions stored thereon; and
said processing device configured to execute the executable instructions to cause the processing device to perform operations comprising the steps of:
via a security and permissioning module: (i) enabling secure communication between said platform and various blockchains, each said blockchain including a plurality of validator nodes for participating thereon, each said blockchain having a required permission and in a current state, said permission being for an asset or a service, and, (ii) establishing a unified permission layer across said various blockchains such that modifications of said permission on said various blockchains are received and executed solely from said platform, thereby governing and dynamically adjusting access to said various blockchains, wherein said unified permission layer enables protocol-level enforcement of access control for said various blockchains, and, (iii) propagating said modifications across said various blockchains;
via an execution module communicating with said security and permissioning module and said unified permission layer, validating transactions within constraints of said unified permissions layer and between each of said validator nodes, and reading and initiating state changes to said current state across said various blockchains to thereby form an updated state and propose valid blocks for said various blockchains;
via a consensus module communicating with said execution module, determining a consensus networking topology across any of said validator nodes participating so a consensus can be reached and so said updated state can be propagated;
whereby said platform bridges one or more of said assets or said services with existing public and private versions of said various blockchains using said unified permission layer, thereby allowing an asset issuer to issue compliant versions of said assets or said services, and access liquidity and user participation across said various blockchains.

2. The system of claim 1, further comprising, via a staking security module, communicating with said consensus module and said security and permissioning module, wherein said staking security module stakes said assets.

3. The system of claim 2, wherein for the step of validating transactions by said execution module, said assets are delegated to a permissioned validator set, said permissioned validator set further validating said transactions and also publishing prices and posting proof of reserves.

4. The system of claim 1, wherein said assets are fungible tokens selected from the group consisting of Layer 1 tokens, Layer 2 tokens, stablecoins, wrapped tokens, governance tokens, utility tokens, security tokens, tokenized fungible Real World Assets (RWAs) and Liquid Staking Tokens (LSTs).

5. The system of claim 1, wherein said assets are non-fungible tokens selected from the group consisting of Real World Assets (RWAs) and NFTs.

6. The system of claim 1, wherein said assets are financialized assets selected from the group consisting of synthetics, cross-chain liquidity tokens and security tokens.

7. The system of claim 1, wherein said security and permissioning module further comprises pre-configured security settings fit for purpose of said asset issuer, said preconfigured security settings determine how to securely communicate and give or receive instructions to or from said various blockchains.

8. The system of claim 7, wherein said preconfigured security settings include at least one required signature, and wherein a number of said signatures is tailored and updated by said asset issuer solely within said platform.

9. The system of claim 1, wherein said security and permissioning module permissions a developer of said services on said platform, said service providing utility of said asset.

10. The system of claim 9, wherein a contract for said services on said platform is natively omnichain.

11. The system of claim 1, wherein, using messaging protocols, said assets are adapted to be used as collateral for a loan even when said loan is on a different blockchain of said various blockchains relative to said assets.

12. The system of claim 1, wherein, using messaging protocols, said assets are adapted to be redeemed natively on said platform.

13. The system of claim 11, wherein institutional compliance requirements are built into said messaging protocols.

14. A system, comprising:
a platform, said platform including a memory and a processing device operatively coupled to the memory, said memory having executable instructions stored thereon; and said processing device configured to execute the executable instructions to cause the processing device to perform operations comprising the steps of:
via a security and permissioning module, enabling secure communication between said platform and various blockchains, each said blockchain including validator nodes participating thereon, each said blockchain having a required permission and in a current state, said permission being for an asset or a service;
via an execution module communicating with said security and permissioning module, validating transactions between said validator nodes, and reading and initiating state changes to said current state across said various blockchains to thereby form an updated state and propose valid blocks for said various blockchains;
via a consensus module communicating with said execution module, determining networking between all of said validator nodes so consensus can be reached and so said updated state can be propagated; and,
via a staking security module communicating with said consensus module and said security and permissioning module, (i) staking said assets across validator networks, wherein the staking modifies validator participation dynamically across said various blockchains, (ii) enforcing institutional-grade staking compliance policies such that an issuer can issue permissioned and institutional-grade versions of said assets or said service; and, (iii) bridging said permissioned and institutional-grade versions of said assets or said service with existing public and private versions of said various blockchains, thereby enabling and enhancing liquidity access and user participation across a plurality of available ecosystems.

15. The system of claim 14, wherein for the step of validating transactions by said execution module, said assets are delegated to a permissioned validator set, said permissioned validator set further validating said transactions and also publishing prices and posting proof of reserves.

16. The system of claim 14, further comprising: said security and permissioning module establishing a unified permission layer across said various blockchains such that modifications of said permission on said various blockchains are received and executed solely from said platform, thereby governing and dynamically adjusting access to said various blockchains, wherein said unified permission layer enables protocol-level enforcement of access control for said various blockchains.

17. The system of claim 14, wherein said assets are fungible tokens selected from the group consisting of Layer 1 tokens, Layer 2 tokens, stablecoins, wrapped tokens, governance tokens, utility tokens, security tokens, tokenized fungible real world-assets and Liquid Staking Tokens (LSTs).

18. The system of claim 14, wherein said assets are non-fungible tokens selected from the group consisting of non-fungible Real World Assets (RWAs) and NFTs.

19. The system of claim 14, wherein said assets are financialized assets selected from the group consisting of synthetics, cross-chain liquidity tokens and security tokens.

20. The system of claim 14, wherein said security and permissioning module further comprises pre-configured security settings fit for purpose of said asset issuer, said preconfigured security settings determining how to securely communicate and give or receive instructions to or from said various blockchains.

21. The system of claim 20, wherein said preconfigured security settings include at least one required signature, and wherein a number of said signatures is tailored and updated by said asset issuer solely within said platform.

22. The system of claim 14, wherein, using messaging protocols, said assets are adapted to be used as collateral for a loan even when said loan is on a different blockchain of said various blockchains relative to said assets, and, wherein, using said messaging protocols, said assets are adapted to be redeemed natively on said platform.

23. The system of claim 22, wherein institutional compliance requirements are built into said messaging protocols.

24. A method, comprising the steps of:
enabling secure communication between a platform and various blockchains, each said blockchain including a plurality of validator nodes for participating thereon, each said blockchain having a required permission and in a current state;
establishing a unified permission layer across said various blockchains such that modifications of said permission on said various blockchains are received and executed solely from said platform, thereby governing and dynamically adjusting access to said various blockchains, wherein said unified permission layer enables protocol-level enforcement of access control for said various blockchains;
propagating said modifications across said various blockchains;
validating transactions within constraints of said unified permissions layer and between each of said validator nodes, and reading and initiating state changes to said current state across said various blockchains to thereby form an updated state and propose valid blocks for said various blockchains;
determining a consensus networking topology across any of said validator nodes participating so a consensus can be reached and so said updated state can be propagated;
staking said assets across validator networks, wherein the staking modifies validator participation dynamically across said various blockchains;
enforcing institutional-grade staking compliance policies such that said asset issuer can issue permissioned and institutional-grade versions of said assets; and,
bridging said permissioned and institutional-grade versions of said assets with existing public and private versions of said various blockchains, thereby enabling and enhancing liquidity access and user participation across a plurality of available ecosystems.
